(19) United States
(12) Patent Application Publication
(10) Pub. No.: US 2018/0112851 A1
(43) Pub. Date: Apr. 26, 2018

(54) LIGHT HYGIENE DEVICE FOR RETROFITTING EXISTING LAMPS

(71) Applicant: High Extraction Full Color Home LED Lighting, LLC, Dunkirk, NY (US)

(72) Inventor: Alan C. Haungs, Dunkirk, NY (US)

(73) Assignee: High Extraction Full Color Home LED Lighting, LLC, Dunkirk, NY (US)

(21) Appl. No.: 15/787,085

(22) Filed: Oct. 18, 2017

Related U.S. Application Data
(60) Provisional application No. 62/411,527, filed on Oct. 21, 2016.

(51) Int. Cl. F21V 9/08; F21V 17/10; F21V 17/16

(52) U.S. Cl. CPC F21V 9/08; F21V 17/164; F21V 17/105

(57) ABSTRACT

Taught is a magnetically-attachable snap-on light-filter system to block unwanted light wavelengths, such as blue light, emanating from available lamps and bulbs to prevent disruption of circadian rhythm to protect people from light-induced damage to their emotional and physical health and/or retinas. The magnetically-attachable filters have intensely sharp light-extinction curves compared to typical filters/eyewear that usually have gradual light-extinction curves. One magnetically-attachable filter design easily, rapidly, and securely magnetically attaches directly to a SORRA Snap-on bulb. Another style of magnetically-attachable filter systems of the present invention is a multi-magnet filter device to be used to filter light emanating from metal-rimmed light fixtures, such as recessed light fixtures, whether LEDs, incandescent, fluorescent, halogens, halides, or sodium. The light-filtered by the snap-on magnetic filter can be configured as desired with a variety of Snap-on SORRA accessories, including beam spreaders and shapers. The filters also provide for green light to alleviate migraine.

### CROSS-REFERENCE TO RELATED APPLICATIONS

This is a Non-Provisional Application of Provisional Application 62/411,527 filed on Oct. 21, 2016.

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISK APPENDIX

Not Applicable

### BACKGROUND

The present invention relates generally to lighting and in particular to the method and device that are used to reapportion spectral output of existing rimmed light fixtures and of SORAA Snap LEDs to eliminate timing-sensitive artificial-light-driven maladies caused by selective EMS wavelengths especially those disrupt the circadian rhythm or aggravate migraine.

The background information discussed below is presented to better illustrate the novelty and usefulness of the present invention. This background information is not admitted prior art.

Modern, currently available, lighting is designed to optimize luminosity. It achieves optimization, in part, by creating a custom-proportioned spectral output for their lamps. However, some of these spectral outputs are known to deteriorate circadian rhythm health, emotional and physical health, and/or retinal health.

Circadian rhythm is synchronized in our bodies by the 24-hour light-dark cycle. White light, especially blue-enriched light, is a natural stimulant that increases alertness and performance. Blue-rich light, regardless of time of day, is a stimulant. Mid-day sunlight gives the brightest white light overall and the proportioning of all colors within this white light are very similar. But, early morning and dusk/evening white sunlight contains the most unbalanced proportioning of colors in that they are blue deficient and thus appears to be yellow or orange-rich light. Pre-lunch-time light exposure is important as it is during this time that light hitting the retina shortens and shifts forward the circadian cycle the most. Light after lunch and before dinner moves the circadian rhythm forward or backward to a much lesser degree. This property is called the circadian light phase response. Morning-time light is required to excite the retina, for otherwise the blinded circadian cycle behaves as if the planet rotates every 24 hours and 15 minute. Morning light exposure to the retina works to shorten the circadian rhythm by 15 minutes back to 24 hours. But, blue enriched white light after dinner re-lengthens, (sometimes greatly), the circadian rhythm and thus increases the error causing melatonin onset to occur too late for the end-of-day and thus shortens the melatonin duration in the blood stream, as such lighting shortens the time the retina is in adequate darkness. Light affects circadian rhythm and, thus also sleep. When photo-sensitive cells in the eye (intrinsically photosensitive retinal ganglion cells) detect light they send a message directly to the areas of the brain (suprachiasmatic nucleus) that regulate circadian rhythm (pineal gland in the brain that produces melatonin) and alertness. These retinal cells respond differently to individual wavelengths of light and are most sensitive to blue wavelength light. The sun emits a light spectrum containing blue wavelength content that the brain interprets as representing daytime and signals the body to be alert. However, fluorescent, CFL (compact fluorescent lamp) and LED light bulbs also emit a spectrum of light with a high concentration of blue wavelengths that tells the brain to wake up. These levels are even higher in blue light than noon sunlight. This overabundance of blue light is designed to offset the higher than normal yellow light. Together this combination of enriched yellow and blue content elevates the light source's luminosity by design while maintaining its “whiteness”. Similarly, computer and electronic device screens emit an even higher level of concentrated blue wavelength light than noon sunlight. When exposure to blue-enriched light occurs just prior to bedtime, it causes circadian disruption which includes disrupting the body's ability to fall asleep, but also affects the body's ability to fight cancer, diabetes, obesity, heart disease, metabolic syndrome, migraine, mania, other metal maladies, as well as causing sleep disruption. Exposure to blue-enriched light can also affect cognition, metabolism, and mood.

In comparison, green light is unique in its effect and health. While white, blue, amber and red lights all exacerbate migraine headache, low-intensity green light seems to reduce it. And migraine pain can be decreased proportionally by decreasing the amount of green light entering the eye because as green light gets brighter it is less soothing. In contrast, migraine headache intensity is increased intensely by blue or red light entering the eye, regardless of the intensity of the blue or red light, where as white or amber light increases the intensity of migraine pain proportionally with the intensity of the white or amber light entering the eye. In other words, pure low intensity green light soothes and reduces the effects of migraine. All other light colors entering the eye increase migraine intensity either proportionally or radically.

It has been shown that photochemical damage to retinal tissue, is more a function of wavelength than either intensity or duration. The human retina contains five known photoreceptors each with their individual action spectrums in combination with retinal circuitry and the brain to form the basis of 3 sub-systems; the Meltopic, Scotopic and Photopic sub-systems. see FIG. 9, from: 2015 Cao D., Nicandro N., and Barrionuevo P. A.; A five-primary photo-stimulator suitable for studying intrinsically photosensitive retinal ganglion cell functions in humans: Journal of Vision 15(1):27, 1-13 http://www.journalofvision.org/content/15/1/27

The Meltopic system is the time of day and year cellular synchronization system. The Scotopic system is the night-time black and white vision system. The Photopic system is the day-time color vision system. Each of these sub-systems is subject to light hygiene issues, and each has its own action spectrum identifying the various wavelengths/colors of light that impact it most. See FIG. 10, from: Spectral Identification of Lighting Type and Character; Elvidge C. D., Keith D. M., Benjamin Tuttle B., and Baugh K. E.

From FIG. 11 and the other graphs we can see that blue light effects the Meltopic system the most, cyan light the Scotopic system the most, and yellow-green the Photopic system the most. Thus, it is easy to understand that light timing, duration, and intensity, as well as wavelength, are determining factors of light hygiene. Additionally, in combination with timing, duration and intensity, light-color composition can either positively or negatively affect health. For example, migraine headache and the resulting photo-phobia are tied to the Photopic system (cone-driven retinal pathways). And, to complicate matters further, the Photopic system is subdivided into three subsystems: S-cone, M-cone and L-cone. It was found that a migraine can either be relived or irritated by a person being exposed to certain wavelengths of light and not others and by the intensity of the light entering the eye.

Color composition/timing/duration, through the Meltopic system, drives circadian rhythm which, in turn, determines the amount of time and quality of cellular repair. Sunset and noon sun have different color compositions, and it is this color composition change that impacts the daily circadian rhythms of life on earth and maximizes and balances cellular repair and productivity. FIG. 12 illustrates black body radiator emission which closely matches a noon-sun (approximately 5777K) and a sunset (approximately 1800K). Notice the difference in color composition. From: Dariusz Kowalczyk—Own work, CC BY-SA 3.0, https://commons.wikimedia.org/w/index.php?curid=20328625. The artificial lighting with its poor light-hygiene that is used in winter evenings affects the circadian rhythm that accommodates cellular summer and winter adaptations. Because light bulbs do not undergo the color composition change of natural light that occurs daily from noon-sun to sunset during the change of seasons, their light forces a perpetual-summer-adaptation on cells. In other words, our body cells are prevented from going into a winter adaptation due to light bulb usage. This perpetual-summer-adaptation timing/duration even exceeds the maximum short-lived summer peak length of day, (which in Buffalo, N.Y. is about 15 hours of total natural daylight) by simulating an unnatural 16-hour noon-sun eye exposure throughout the day, regardless of the hour. As this light-time overage typically occurs for all 365 days of the year, a person can never recover from the long-summer-day-adaptation despite the body being programed to have a summer adaptation followed by a cellular winter adaptation. This summer adaptation minus the following winter adaptation affects our body's ability to repair and heal itself as the body is carving carbohydrates as it is trying to store fat perpetually for a winter adaptation that never follows. Poor light-hygiene erodes mental function and aggravates or amplifies many pre-existing maladies. Unfortunately, the body's natural maximization and balance is fouled by the usage of the light bulb, as a light bulb's color composition remains unchanged throughout the daily cycle. The color composition/timing/duration of light bulbs and their common usage is a major contribution of poor light hygiene.

### SUMMARY

The present Inventor, realizing that while today's light bulbs satisfactory supply an excellent amount of light for us to work or play throughout the day, that very same amount of light during the wrong time is no longer beneficial, but detrimental. It is well-accepted that the human body requires sleep, in order to accomplish many required biological functions, and that sleep comes naturally when the light of natural day changes from light with a strong percentage of blue light to light that decreases its amount of blue day as evening approaches. Accordingly, the present inventor visualized an inventive concept that provides for a light-filter system to be used as needed on presently used bulbs. These red, orange or yellow removable filters greatly attenuate the passage of the blue light wanted in the morning but that is harmful to our circadian rhythm later in the day to prevent disruption of the circadian rhythm to protect us from light-induced damage to our emotional and physical health, and/or retinas.

Accordingly, the present inventor developed inventive principles from his inventive concept to make it possible for people to easily and rapidly use light-filters that optimize color (wavelength) composition for specific light hygiene purposes. His first step was to identify and choose filters have intensely sharp light-extinction curves as compared to typical filters/eyewear that usually have gradual light-extinction curves. Realizing that at this time it appears impractical for the lighting-industry to produce lighting fixtures with built-in filters or bulbs whose color composition can change as needed, another inventive principle the present inventor developed from his inventive concept is to provide quickly removable, easily attachable, light hygiene devices that are magnetically attachable to a variety of existing bulbs, lamps and light fixtures as needed at any hour of the day and are just as easily detachable from those lights, to provide color rendering white light when needed.

As there are various types of lights currently available, including SORRA Snap-on bulbs, the Inventor designed several filter systems. The first is a system that is used to filter light directly from a SORRA Snap-on bulb using magnetically-attachable filter systems that are designed to easily, rapidly, and securely magnetically attach to a typical SORAA Snap bulb. The filter is either a red, orange, green, or yellow filter. SORAA Snap bulbs differ from the present invention in that a SORAA Snap lamp is a directional/projective style LED that produces light with a high color rendering index and light whiteness. A SORAA Snap bulb is built with a magnet that can magnetically hold onto an additional lens that provides for various degrees of increased beam divergence, and/or onto a magnetically snapped on filter that reduces color temperature i.e., produces warmer light, while maintaining a high color rendering index and light whiteness. As the aim of the present invention is to address health issues, the preservation of white light high-color rendering and light “warming” is not a considered, and, in fact, has been traded for the elimination of health-offending color. For example, the existing SORAA white light-warming filter systems will smoothly reduce blue transmission; while in contrast, the red and orange filter of the present invention almost totally and abruptly eliminates it. Additionally, the yellow lens of the present invention eliminates most of the blue, and the green filter eliminate the red and blue, hence the whiteness of the light is lost, for the light coming through the filter is a color, not a version of white (i.e., not a warmer or cooler white). In contrast, a color warming filter, such as used by SORAA, smoothly increases the elimination of colors as one moves through the spectrum from red to violet, precisely because they want to preserve whiteness and the high color rendering index.

Another style of magnetically-attachable filter system of the present invention is a multi-magnet light-filter device designed to be used to filter light from light bulbs contained in metal-rimmed light fixtures, such as recessed light fixtures, whether LEDs, incandescent, fluorescent, halogens, halides, or sodium. Essentially, the invention is a multi-magnet magnetically-attachable snap-on filter that provides the light-spectra that is needed when it is needed. The multi-magnet filters offer filter devices with as many magnets required to securely attach the filter device to a rimmed light fixture while providing for the filter to be easily and rapidly removed when filtered light is no longer required. Through each filter used in the multi-magnet design are a multiple of spaced screws or the like for each to retain a magnet on the side of the filter that will snap-on to the metal rim of the ceiling light fixture. The magnetically-attachable filter systems of the present invention each offer a filter of choice; red, orange, yellow, or dark green, with the red filter entraining circadian rhythm for day-time sleep for persons who work night-shift, the orange filter entraining the circadian rhythm for night-time sleep, the yellow filter for low vision persons to entrain circadian rhythm for evening sleep, and/or for retina protection for all occasions caused by retinitis pigmentosa or macular degeneration, and the dark green filter is for migraine relief. A typical person sees wavelength between 750 nm (red) to 380 nm (violet). For simplicity all humanly visible light wavelengths can be divided into the red, orange yellow, green, blue and violet. Again, for simplicity and assuming less than 1 % transparency is called blocking and over 1 % transparency is treated as transmission: a red filter passes 590 nm to 750 nm or blocks 380 nm to 590 nm or blocks yellow, green, blue and violet light. An orange filter, used in the present invention, passes 540 nm to 750 nm or blocks 380 nm to 540 nm or blocks half of green, and all of blue and violet light. A yellow filter, used in the present invention, passes 480 nm to 750 nm or blocks 380 nm to 480 nm or blocks most of blue, and all of violet light. As circadian rhythm is mostly an abundance of light at the wrong time the best way to understand the virtues of the filters is through their blocking numbers as they emphasize the blue (450 nm-495 nm) blocking nature of the lenses used in the present invention. Note that the yellow lens allows for a small sliver of blue light to transmit, because the orange might be too dark for some to use. Taking this into consideration, the filters of the present invention allow the passage of the desired colors while abruptly removing undesired colors (as moving through the color spectrum radio-metrically). It is this removal of certain colors that destroys the whiteness and high color rendering. It is obvious then that currently available light sources (bulbs and lamps) precisely want to preserve whiteness and the high color rendering index and they do so by using a color warming filter, such as the filters used by SORAA, resulting in a smooth increase in the elimination of colors traveling through the spectrum from red to violet. In contrast, the present invention, as discussed, explicitly teaches the abrupt removal of the undesired colors (moving through the color spectrum) know that this will, in fact, destroy whiteness and high color rendering. The light-filter systems are inexpensive to manufacture, easy to use, and are appropriate for home, office, and industrial use. The present invention provides for people to provide the light that they require whether it is the naturally relaxing light of evening time or light specifically designed to alleviate migraine headaches with minimal expense and little effort.

Still other benefits and advantages of this invention will become apparent to those skilled in the art upon reading and understanding the following detailed specification and related drawings.

### BRIEF DESCRIPTION OF THE DRAWINGS

In order that these and other objects, features, and advantages of the present invention may be more fully comprehended and appreciated, the invention will now be described, by way of example, with reference to specific embodiments thereof which are illustrated in appended drawings wherein like reference characters indicate like parts throughout the several figures. It should be understood that these drawings only depict preferred embodiments of the present invention and are not therefore to be considered limiting in scope, thus, the invention will be described and explained with additional specificity and detail through the use of the accompanying drawings, in which:

FIG. 1 is an exploded view of the snap-on magnetic filter of the present invention and the SORAA snap LED light bulb to which it will be attached;

FIG. 2 is a perspective view of the assembled snap-on magnetic filter;

FIG. 3 is another perspective view of the assembled snap-on magnetic filter;

FIG. 4 is a plan view illustrating the assembled snap-on magnetic filter of the present invention attached to the SORAA snap light bulb.

FIG. 5 is an exploded perspective view of a snap-on magnetic filter of the present invention to be secured onto a steel rim of a recessed ceiling fixture.

FIG. 6 is perspective view of the snap-on magnetic filter magnetically secured onto a steel rim of a recessed ceiling fixture as illustrated in FIG. 5.

FIG. 7 is a plan view of another style snap-on magnetic filter secured onto a steel rim of a recessed ceiling fixture.

FIG. 8 is a graph of the spectral sensitivities of the five known photoreceptors.

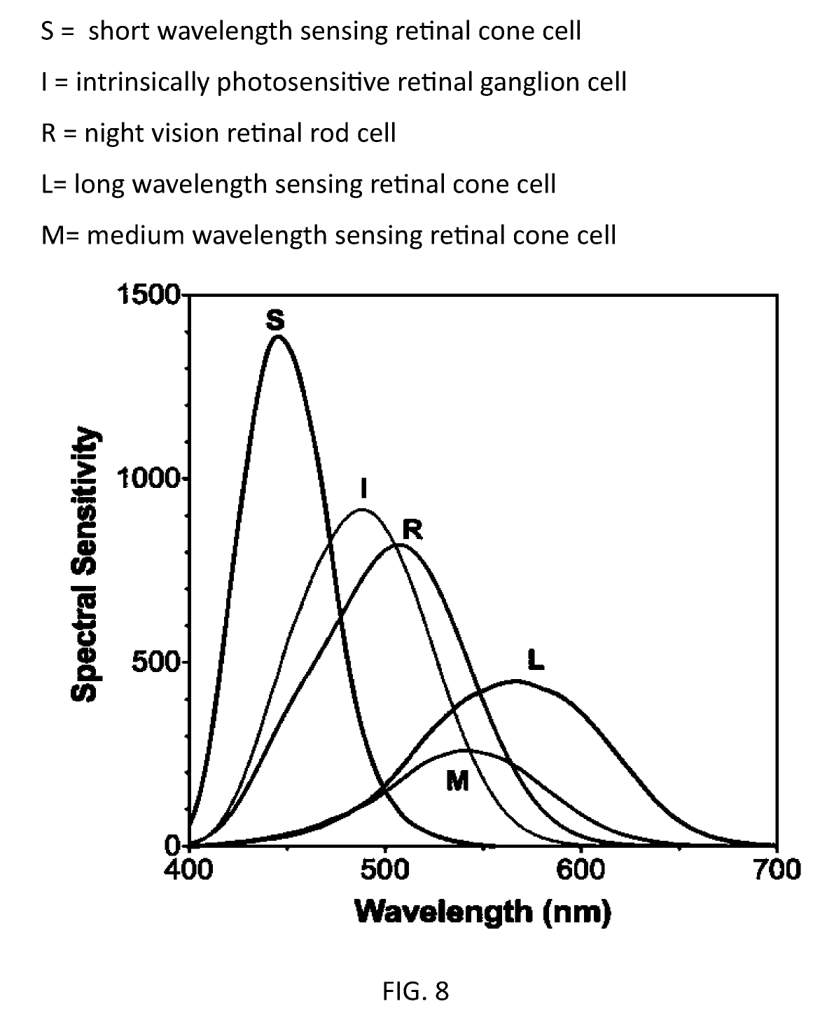

FIG. 9 is a graph of the response curves of the three human photoreceptors.

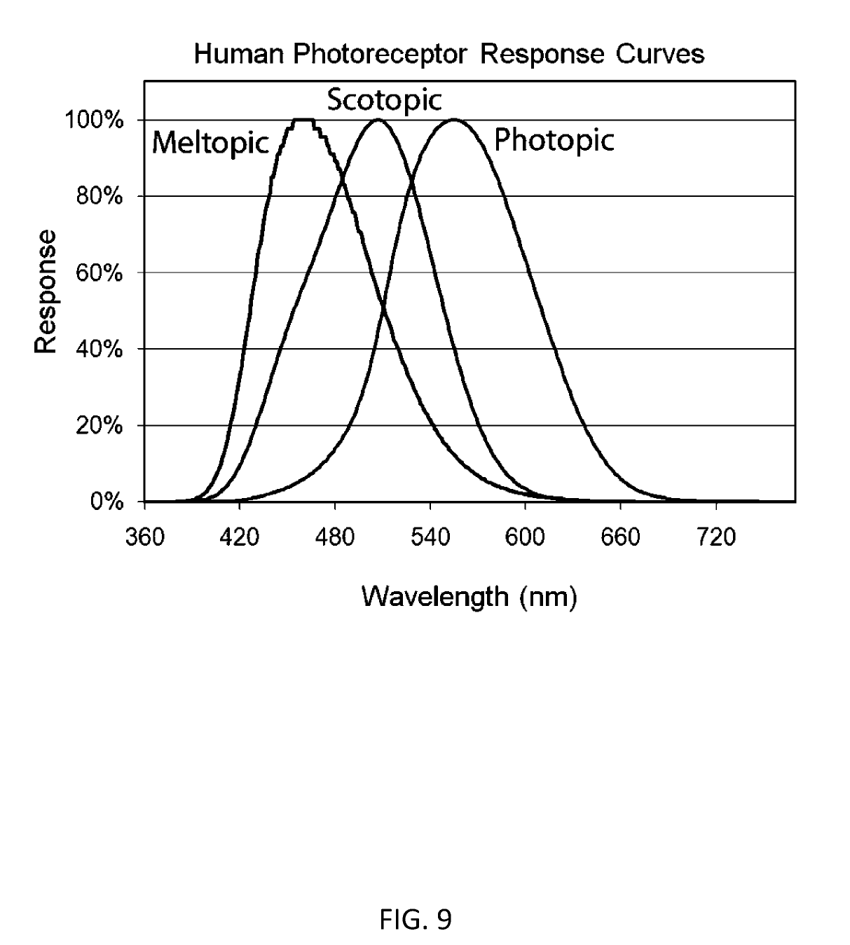

FIG. 10 is a graph of the visible wavelengths of the electromagnetic spectrum.

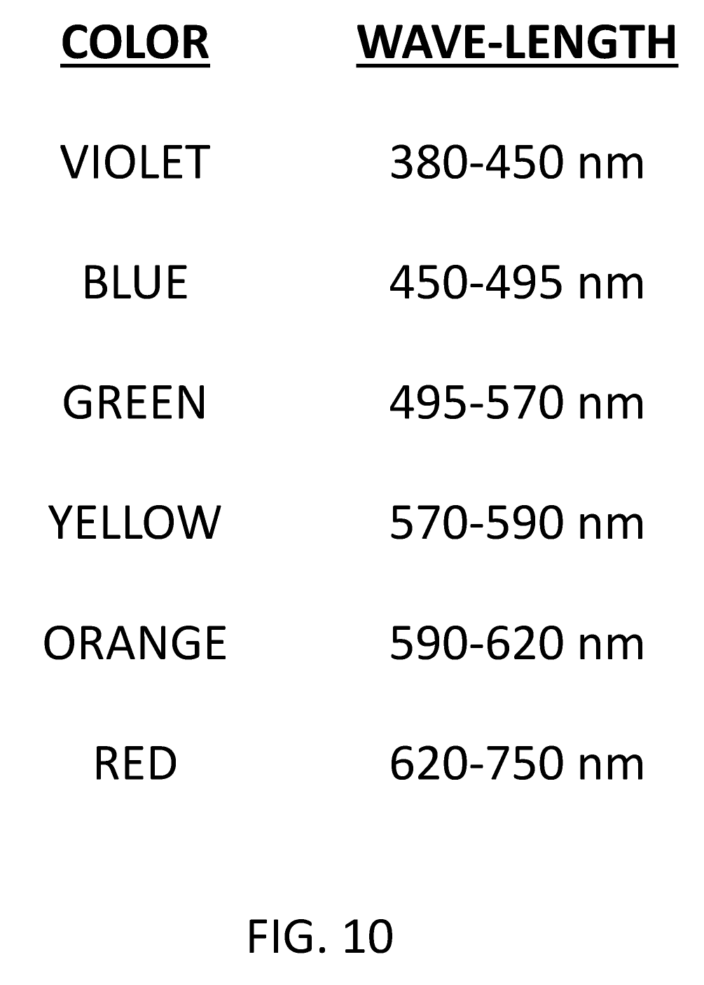

FIG. 11 is a set of graphs showing black body radiator emissions.

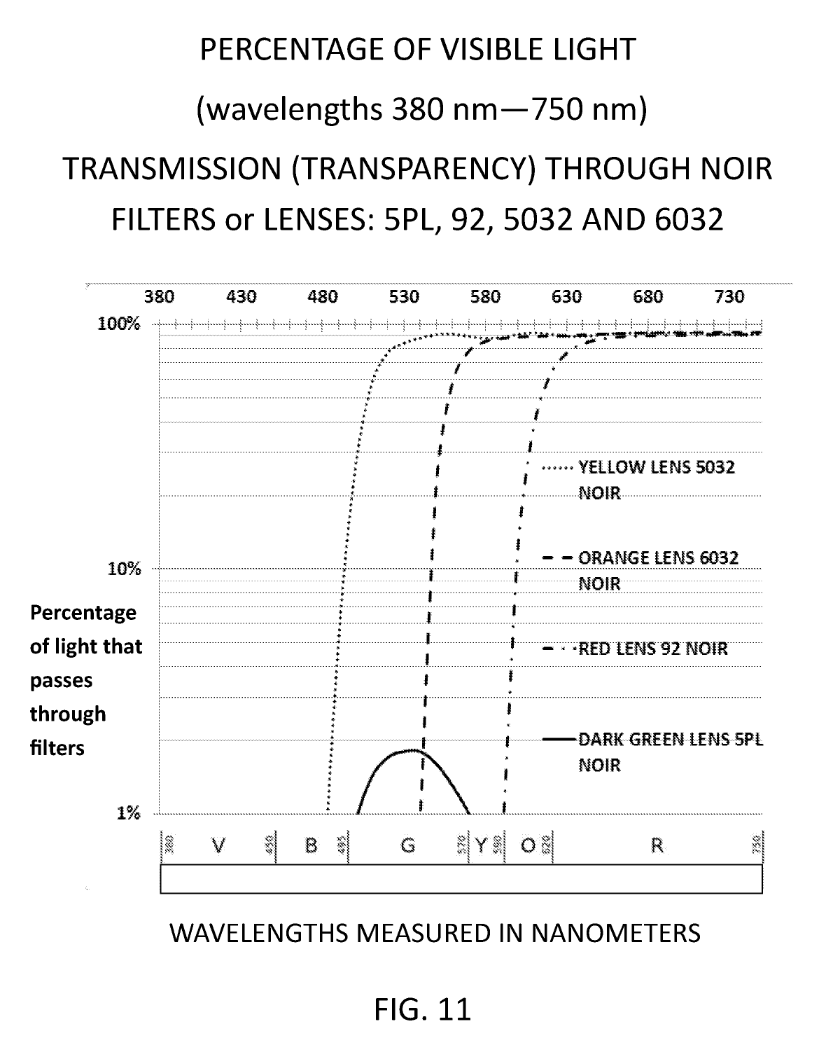

FIG. 12 is a graph showing the percentage of light that passes through differently colored filters.

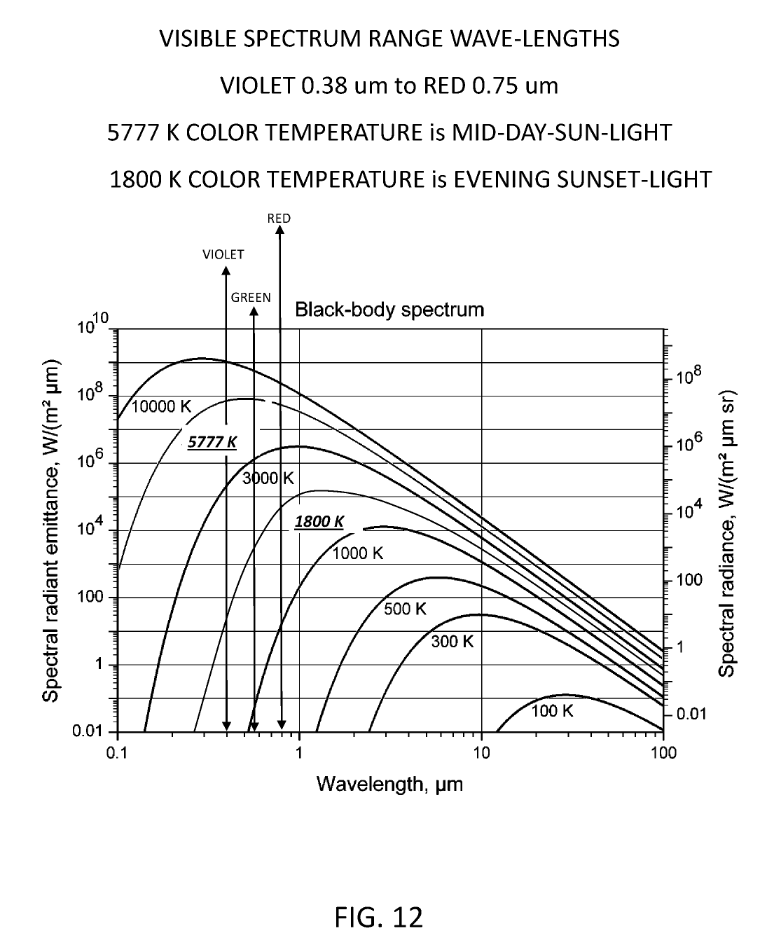

### LIST OF REFERENCE NUMBERS AND THE STRUCTURE TO WHICH THEY REFER

2 Finial.

4 Finial extender or adapter.

6 Nut or optional thread adapter/reducer.

8 Filter.

10 Filtering device.

12 Magnet with through-aperture.

14 Screw.

16 Strong-hold magnet.

18 Soft bumper stick on.

90 Steel rim of recessed ceiling light.

100 SORAA Light Bulb.

### DETAILED DESCRIPTION

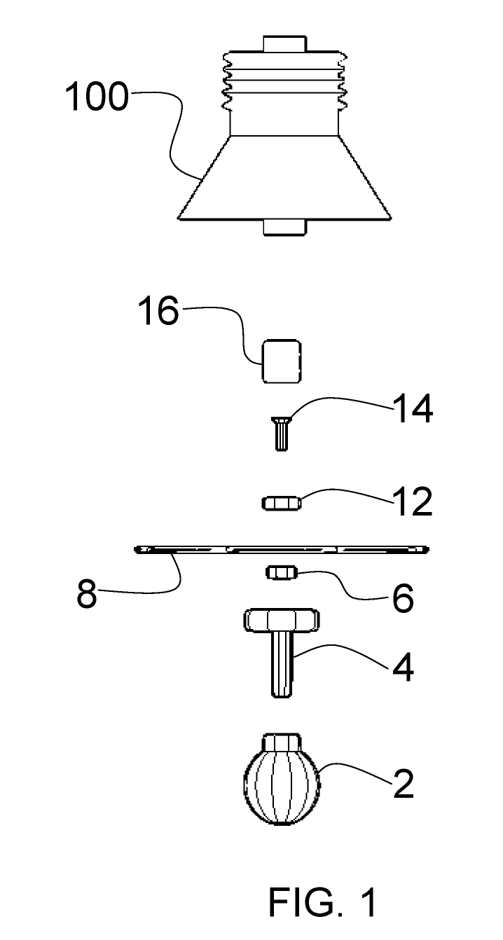

FIG. 1, an exploded plan view, illustrates the structural parts of a magnetic snap-on filter device of the present invention comprising a decorative finial 2, a finial extender 4, a nut 6, filtering disc 8, magnet 12, screw 14, strong-hold magnet 16, and the SORAA Snap-on light bulb 100 to which the magnetic filter will be magnetically attached. Finial 2 is an optional, arbitrary decorative finial that can be used as a knob, handle, or cap. Finial extender 4 is also optional and can be an extender or an adapter. Nut 6 can be an optional thread adapter/reducer for finial extender/adapter 4 or an arbitrary and optional decorative finial, knob, handle or cap. Filtering disc 8 is an optical filtering disk of arbitrary shape and color which depends on the desired style, shape, size and use of the SORAA Snap lamp fixture and can be a red, orange, green, or yellow filter. Another example of the present invention contemplates an octagonal filtering disc. In some examples, the filtering disc is circular, and in yet other designs, the filtering disc is square. The filter color (that is, the desired transmission curve produced by the filter) to be used depends on the desired light hygiene application. Magnet with through aperture 12 is donut-shaped with a counter sunk through-aperture to accommodate screw 14 and screw head and may be plastic covered, if so desired. The countersunk magnet cylinder 12 may be configured to accommodate various size screws or screw heads based on the styling required. The countersunk magnet cylinder may have different lengths for each application of the device based on dimensional requirements. Strong-hold magnet 16 may be used for distance extension and to secure the filter arrangement to the bulb or to the housing of a lighting fixture. In some embodiments, in optional bumper or plastic covered magnet is provided at the base of the finishing cylinder. The optional bumper or plastic covering may prevent damage or scratches to the lighting fixture each time the device is removed or attached. The thickness of the optional bumper or plastic covering may be adjusted to provide enough adhesion as to prevent accidental the attachment of the device, but allow the device to be moved easily when done so intentionally. The SORAA Snap light bulb 100 is a projection styled light bulb with a holding magnet on its face center. It should be understood that the device of the present invention may comprise one or more finials, knobs, caps or handles, as desired. The finials may be manufactured from a variety of materials, such as plastic or metal. The design of the finials may vary based on preference or dimensional requirements. In the embodiment illustrated in FIGS. 1-4, the finial is contemplated to have an opening threaded to accept a screw. The finial may also be configured to connect with the rest of the device using a different type of mechanical adapters. In some embodiments, an optional adapter may be required depending on thread mating, design, or dimensional requirements. The adapter may be cylindrical with one end having threading configured to mate with the finial, and a second end of a second diameter having an opening threaded to accept various components. The optional adapter may come in other shapes or sizes such that it attaches to the finial and the rest of the device. The optional adapter may be translucent, transparent, or opaque. The optional adapter may be made from various materials such as plastic or metal. Although several parts are optional, such a filter arrangement always has the following: a filter, one donut center magnet, one solid center magnet, screws, nuts, and bushings as needed to retain the donut magnet against filter.

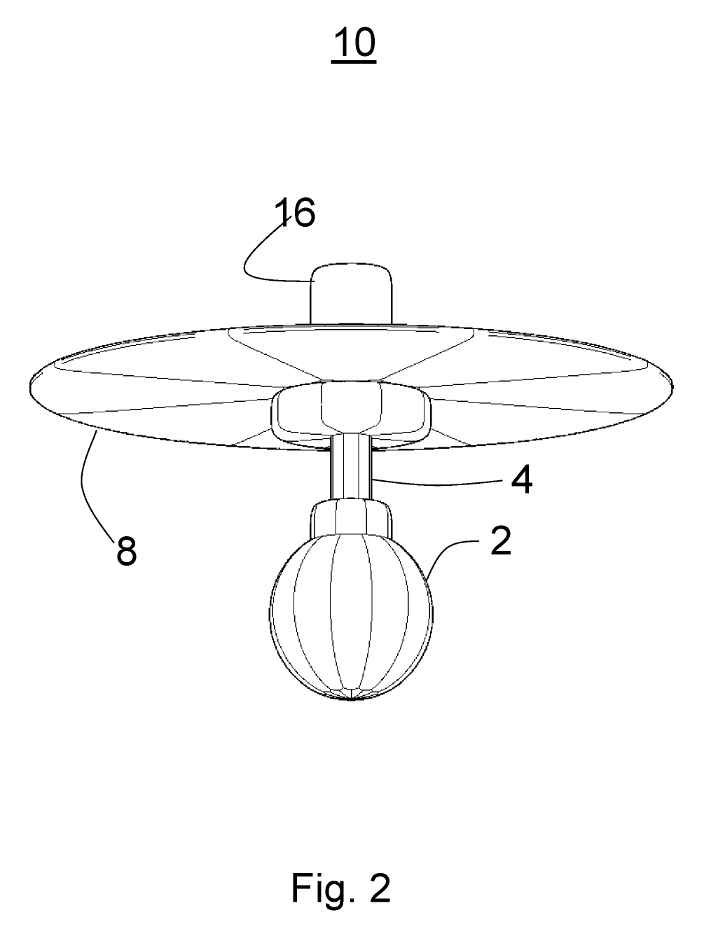

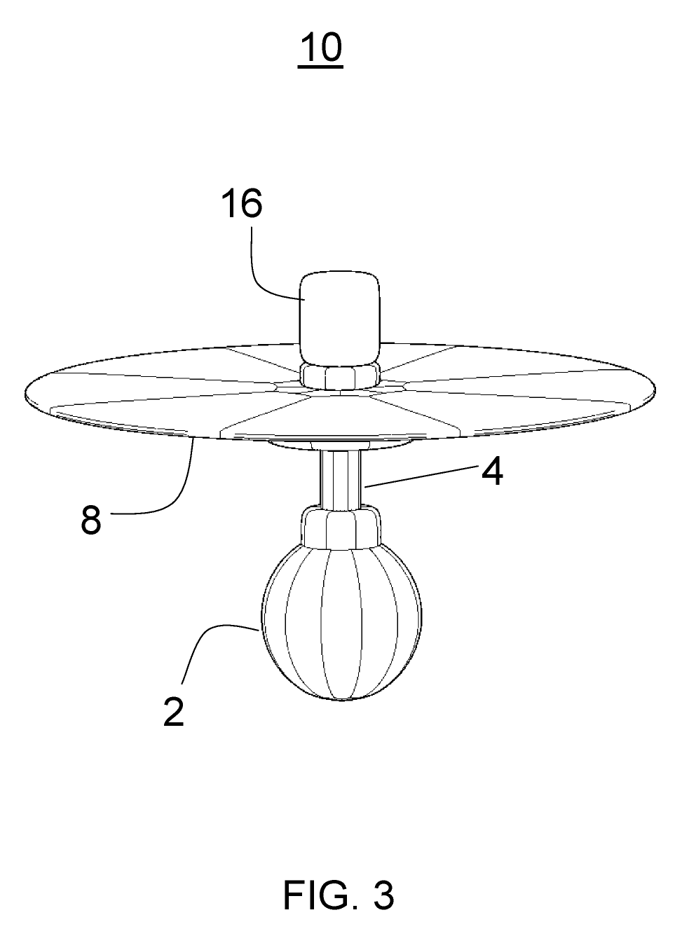

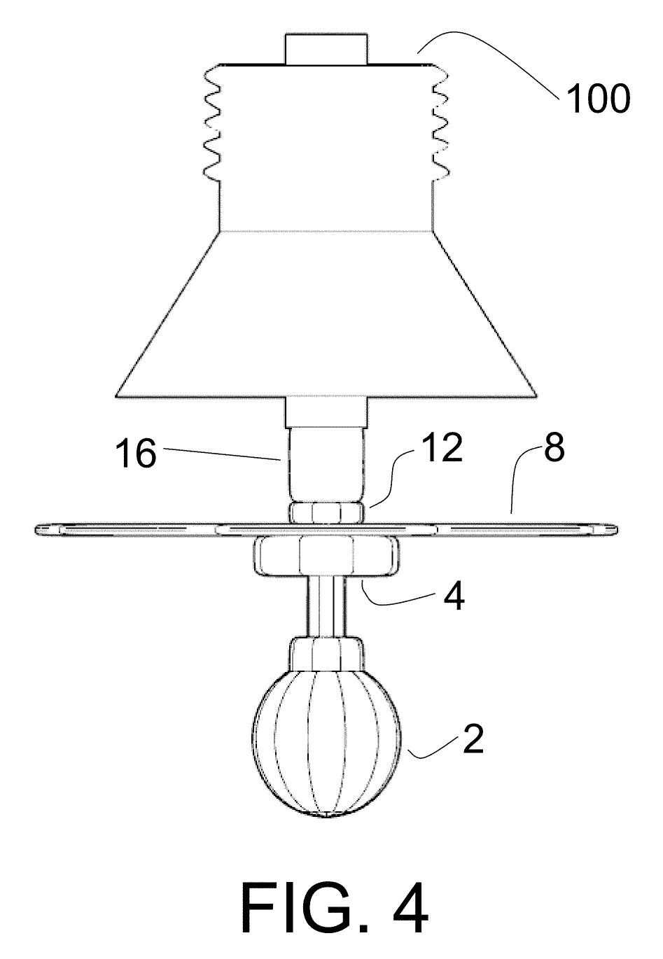

FIG. 2, a perspective view, illustrates assembled snap-on magnetic filter 10 and FIG. 3 provides another perspective view of the magnetic filter. The magnetic snap-on filter device of the present invention is assembled, in the example illustrated in FIG. 4, by positioning the aperture of magnet 12 on filter 8 so that it is aligned with the centered-aperture of filter 8 to accept screw 14 that is then passed through through-aperture magnet 12 and filter 8 into nut 6 that is then threaded into finial extender 4 to be threaded into decorative finial 2 for secure attachment. It is contemplated that Parts nut 6, finial extender 4, and decorative finial 2 can be substituted by a cap nut or threaded knob. This assemblage is then attached to, i.e., magnetically held by, the SORAA Snap lamp. The attachment is accomplished by first using magnetically attaching strong-hold magnet 16 to the assembled filter device and then simply positioning the assembled filter device under the SORAA Snap blub so that the magnet in the SORAA Snap bulb attracts and holds the magnetic assembled filter.

FIG. 4, a plan view, illustrates the snap-on magnetic filter of the present invention magnetically attached to a SORAA Snap light bulb. It is easily understood that the snap-on magnetic filter of the present invention literally snaps onto the magnetic SORAA Snap bulb easily, quickly, and securely simply using magnetic attraction between strong-hold magnet 16 of the present invention and magnet 105 of the SORAA Snap bulb. Removing the snap-on magnetic filter of the present invention from the magnetic SORAA Snap bulb is just as quickly and easily accomplished simply by disengaging magnet 16 of the present invention and magnet 105 of the SORAA Snap bulb. The ease of attachment and detachment provides for users to filter light from the SORRA Snap lamp that is adequate for day-light use, to another desired light, such as the relaxing light produced by using an orange or red filter to block the blue light that we want earlier in the day but that is harmful to our circadian rhythm later in the day. The present invention provide for light hygiene that is that easy and within the capabilities and budget of anyone wishing to do so.

Another benefit afforded by the present invention is that while the filter of the present invention is filtering the light emitted by a SORAA Snap blub, the light so filtered can be further configured using a variety of SORRA Snap accessories, including beam spreaders and shapers. A magnetic spreader or shaper can be added to the assembly by separating the two magnets of the two-magnet assembled light-filter and sliding the beam shaper or spreader in between them, or by placing the beam spreader or shaper directly onto a SORAA lamp and then placing the two-magnet assembled light-filter on the beam shaper or spreader. In another embodiment, the filtering disc may be comprised of multiple layers, each layer having different attributes (different colors) for filtering light, or alternatively is comprised of multiple filter colors. The device may also comprise a filtering disc of an arbitrary shape (round, square, or other design) depending on the desired style, dimensional requirements, filter color, and light hygiene application

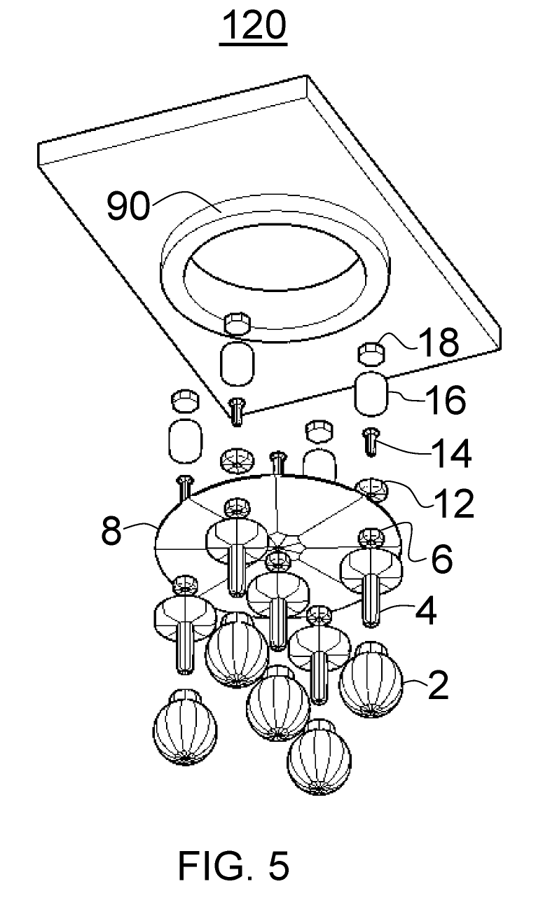

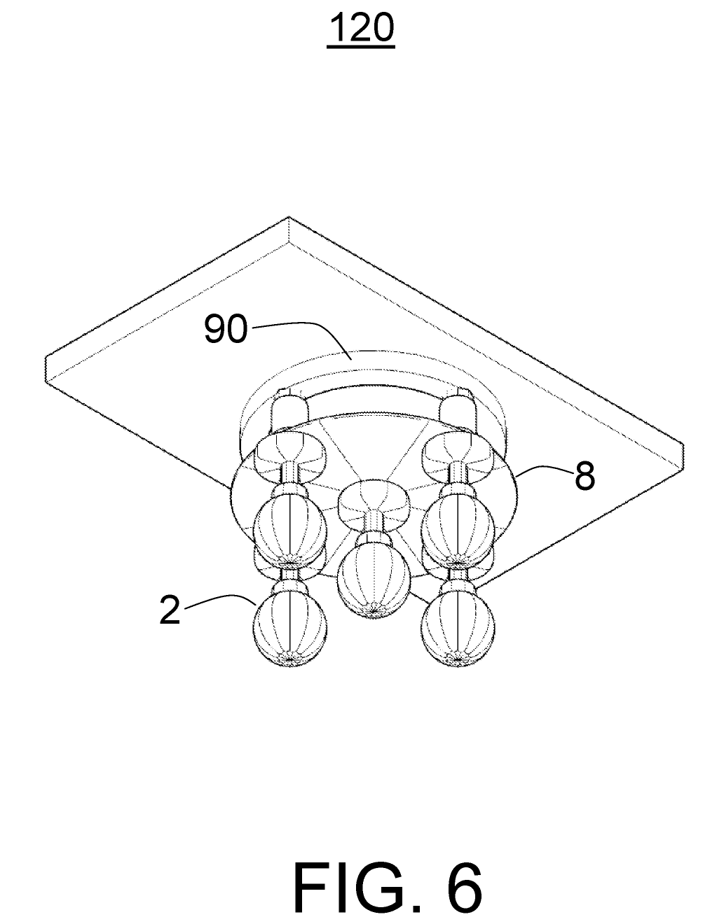

In addition, to the present invention being used on the magnetically-endowed SORAA Snap bulbs, it can also be used with any bulb in a metal-rimmed fixture. FIG. 5, an exploded perspective view illustrates snap-on magnetic filter device 120 to be snap-on secured to steel rim 90 of a recessed ceiling fixture using multiple magnet assemblies adjacent the perimeter of the filter for the purpose of securing the filter device instead of the center of the filtering disc. In this example there are five magnet assemblies employed with four of the five magnet assemblies positioned on the fixture's rim perimeter. Viewing FIG. 6 it can be appreciated that four of the magnetic assemblies require strong-hold magnets 16. It should be appreciated, though, that it is arbitrary how many magnets or how many parts are on each set that are used to hold a filter to a rim as long as there are enough to hold the weight of the filter arrangement. The fifth assembly may or may not supply magnetic hold; it will depend on the configuration of the fixture and the bulb used in the fixture. In some embodiments, not all finials will be attached to a magnet cylinder or bumper. Soft bumper stick-ons 18, in this example, are positioned between strong-hold magnet 16 of the perimeter magnet assemblies and the rim. Each of the multiple-magnet assemblies to be used to attract and attach to a rim of a light fixture is assembled similar to the single-magnet filter devices discussed above. That is, screw 14 is positioned against the aperture of one of the four through-aperture magnets 12 that is aligned with one of the four rim apertures on filter 8. Screw 14 is then passed through the aperture of magnet 12 and filter 8 into nut 6 that is then secured into and held by a finial extender 4 that is positioned within decorative finial 2. Screw 14, in this example, is a machine threaded screw with counter sunk head. In some embodiments, an optional reducer may be required in order to adapt to the finial or optional adapter. The reducer may be held in place using a fiction fit or through another type of mechanical linkage such as a screw or flange. The attachment of the multi-magnet filter assembly is accomplished by first attaching four strong-hold magnets 16 to each of the four assembled magnetic assemblies and then simply positioning the assembled filter device under the rimmed fixture so that the magnets of the magnetic filter assembly attracts and holds the magnetic assembled filter to the rimmed lamp. Such snap-on filter arrangements have at least a filter, a plurality of magnets with an aperture, other additional magnets, and whatever screws, nuts, bushing are needed to retain the donut magnets (those with an aperture) against the magnetic rim.

FIG. 6, a perspective view, illustrates a multi-magnetic filter of the present invention secured onto a steel rim of a recessed ceiling fixture using the magnetic hold of the four perimeter magnet assemblies. The filter is either a red, orange, green, or yellow filter. If desired, the center finial could be attached with extending adapters and be used as a hand-hold to assist in the attachment and removal of the filter assembly from the rimmed fixture. The ease of attachment and detachment provides for users to easily filter light from rimmed lamps that provide light adequate for day-light use, to another desired light, such as the relaxing light produced by using an orange or yellow filter to block the blue light that we want earlier in the day but that is harmful to our circadian rhythm later in the day. The present invention provides for light hygiene that is that easy and within the capabilities and budget of anyone wishing to do so.

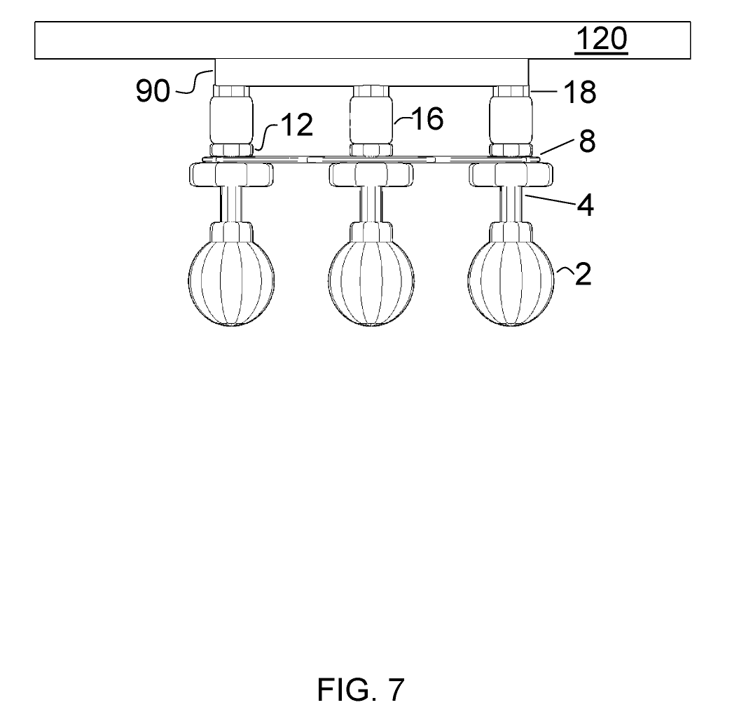

FIG. 7, a plan view, illustrates another style of multi-magnetic filter to be secured onto a steel rim of a rimmed light fixture. The magnetic connection points of the multi-magnet filter assemblies need not be located on the exact perimeter. In some embodiments, the magnetic connection points may be based on the shape and size of the light fixture to which it is designed to be attached, for example, by putting the magnetic connection points in locations that was sufficiently engage with the device.

One advantage of the present disclosure is that the disclosed devices can be quickly attached or the attached from the lighting fixture, for example when using a SORAA MR16 projection LED light bulb, inside of a TwiceBright recessed ceiling light fixture, and other lamp/fixture arrangements.

Although the present disclosure has been described with respect to one or more particular embodiments, it will be understood that other embodiments of the present disclosure may be made, as described above, without departing from the spirit and scope of the present disclosure.

What is claimed is:

1. A snap-on light-filter for filtering SORAA Snap bulb spectral output to optimize color wavelength composition for specific light hygiene purposes, comprising:
a light-filter that when attached to a SORAA Snap bulb generates intensely sharp light-wavelength extinctions of the SORAA Snap bulb spectral output causing spectral output reapportionment eliminating timing-sensitive artificial-light-driven maladies caused by selective light-wavelengths and destroying the whiteness and high color rendering of the emitted light,
said light-filter device being attachable to and detachable from said SORAA Snap bulb providing high color rendering white light when needed.

2. The light-filter, as recited in claim 1, further comprising said filter being a red, orange, green, or yellow filter.

3. The light-filter, as recited in claim 2, further comprising:
a nut (6),
a screw (14),
a strong-hold magnet (16), and
a magnet (12) having an aperture,
wherein the aperture of magnet 12 aligned with a centered-aperture of filter 8 accepts screw 14 and threads it into nut 6 thus creating an assembled said light-filter for future attachment to the SORAA Snap bulb, when desired, by attaching strong-hold magnet 16 to the assembled light-filter to then magnetically snap the assembled light-filter to the SORAA Snap blub so that a magnet in the SORAA Snap bulb attracts and magnetically holds the two-magnet assembled light-filter.

4. The light-filter, as recited in claim 3, wherein said light-filter further comprises:
a finial extender 4,
a finial 2
wherein said screw 14 threaded into said nut 6 is then threaded into said finial extender 4 that is threaded into said finial 2.

5. The light-filter, as recited in claim 4, wherein said filter is comprised of multiple filter colors.

6. The light-filter, as recited in claim 5, wherein said magnet with an aperture is configured to accommodate differently size screws or screw heads based on the styling required.

7. The light-filter, as recited in claim 6, wherein said magnet with an aperture is provided with a length required for each application based on dimensional requirements.

8. The light-filter, as recited in claim 7, wherein said strong-hold magnet is used for distance extension and as a handle to secure the filter arrangement to the SORAA Snap bulb or to the housing of a lighting fixture.

9. The light-filter, as recited in claim 8, wherein a magnetic spreader or shaper can be added to my assembly by separating said two magnets of the two-magnet assembled light-filter and sliding the beam shaper or spreader in between them, or by placing the beam spreader or shaper directly onto the SORAA lamp and then placing the two-magnet assembled light-filter on the beam shaper or spreader.

10. A snap-on light-filter for filtering SORAA Snap bulb spectral output to optimize color wavelength composition for specific light hygiene purposes, comprising:
a light-filter that when attached to a SORAA Snap bulb generates intensely sharp light-wavelength extinctions of the SORAA Snap bulb spectral output causing spectral output reapportionment eliminating timing-sensitive artificial-light-driven maladies caused by selective light-wavelengths and destroying the whiteness and high color rendering of the emitted light,
said light-filter being a red, orange, green, or yellow filter.
said light-filter being attachable and detachable to provide color rendering white light when needed.

11. The light-filter, as recited in claim 10, further comprising:
a nut (6),
a screw (14),
a strong-hold magnet (16), and
a magnet (12) having an aperture,
wherein the aperture of magnet 12 aligned with a centered-aperture of filter 8 accepts screw 14 and threads it into nut 6 thus creating an assembled said light-filter for future attachment to the SORAA Snap bulb, when desired, by attaching strong-hold magnet 16 to the assembled light-filter to then magnetically snap the assembled light-filter to the SORAA Snap blub so that a magnet in the SORAA Snap bulb attracts and magnetically holds the assembled light-filter

12. The light-filter, as recited in claim 11, wherein said light-filter further comprises:
a finial extender 4,
a finial 2
wherein said screw 14 threaded through said nut 6 is threaded into said finial extender 4 that is then threaded into said finial 2.

13. A light-filter assembly designed to be used to filter light from light bulbs contained in metal-rimmed light fixtures, including recessed light fixtures, whether LEDs, incandescent, fluorescent, halogens, halides, or sodium, to optimize color wavelength composition for specific light hygiene purposes, comprising:
a light-filter that when attached to a rim of a metal-rimmed light-fixture generates intensely sharp light-wavelength extinctions of the spectral output of the light-fixture causing spectral output reapportionment eliminating timing-sensitive artificial-light-driven maladies caused by selective light-wavelengths and destroying the whiteness and high color rendering of the emitted light,
said light-filter assembly being attachable to and detachable from the rim of the metal-rimmed light-fixture to provide color rendering white light when needed.

14. The light-filter assembly, as recited in claim 13, further comprising said filter being a red, orange, green, or yellow filter.

15. The light-filter assembly, as recited in claim 14, further comprising multiple sets of:
a nut (6),
a screw (14),
a strong-hold magnet (16), and
a magnet (12) having an aperture,
wherein the aperture of magnet 12 accepts screw 14 and threads it into nut 6 through one of a plurality of apertures in filter 8 thus creating a light-filter assembly for future attachment to and detachable from the rim of the metal-rimmed light-fixture, when desired, by attaching one strong-hold magnet 16 to each of the multiple sets to then magnetically snap the assembled light-filter to the rim of the metal-rimmed light-fixture.

16. The light-filter assembly, as recited in claim 15, wherein one or more of each of said multiple sets further comprises:
a finial extender 4,
a finial 2
wherein said screw 14 threaded into said nut 6 is then threaded into said finial extender 4 that is threaded into said finial 2.

17. The light-filter assembly, as recited in claim 16, wherein a magnetic spreader or shaper can be added to the light-filter assembly by separating said two magnets of the two-magnet assembled light-filter and sliding the beam shaper or spreader in between them, or by placing the beam spreader or shaper directly onto the SORAA lamp and then placing the two-magnet assembled light-filter on the beam shaper or spreader.

18. The light-filter assembly, as recited in claim 17, wherein each of said magnets with an aperture is configured to accommodate differently size screws or screw heads based on the styling required.

19. The light-filter assembly, as recited in claim 18, wherein each of said magnets with an aperture is provided with a length required for each application based on dimensional requirements.

20. The light-filter assembly, as recited in claim 19, wherein each of said strong-hold magnets is used for distance extension and as a handle to secure the filter arrangement to the metal rim of a lighting fixture.
